(19) United States
(12) Patent Application Publication
(10) Pub. No.: US 2026/0337350 A1
(43) Pub. Date: Oct. 29, 2026

(54) RECYCLING OF CATALYST COATED MEMBRANE COMPONENTS

(71) Applicant: JOHNSON MATTHEY PUBLIC LIMITED COMPANY, London (GB)

(72) Inventors: Ross GORDON, Sonning Common (GB); Gareth HART, Sonning Common (GB)

(21) Appl. No.: 19/106,074

(22) PCT Filed: Nov. 7, 2023
(86) PCT No.: PCT/GB2023/052897

§ 371 Date: Feb. 24, 2025

(30) Foreign Application Priority Data
Nov. 18, 2022 (GB) 2217268.8
Dec. 15, 2022 (GB) 2218972.4

(51) Int. Cl. C08J 5/22; C08J 11/08; H01M 8/008

(52) U.S. Cl. CPC C08J 5/2293; C08J 5/2237; C08J 11/08; H01M 8/008; C08J 2327/16

(57) ABSTRACT

A method of recycling a fluorinated polymer from a membrane comprising the fluorinated polymer, the fluorinated polymer comprising a fluorinated polymer backbone chain and a plurality of groups represented by formula —SO₃Z, wherein Z is hydrogen, the method comprising: contacting the membrane with a reagent providing a source of cations to form a fluorinated polymer salt in which Z is a cation, wherein the reagent is maintained at a temperature sufficiently low that the membrane remains in a solid, undispersed form; removing excess, unreacted reagent from the solid fluorinated polymer salt; and after removing the excess reagent, dispersing the solid fluorinated polymer salt in a solvent.

### FIELD

This specification relates to recycling methods for components of catalyst coated membranes such as those used in fuel cells and hydrogen producing water electrolysers.

### BACKGROUND

Fuel cell and hydrogen producing water electrolyser production is set for rapid growth as investment is placed into the global hydrogen economy. Catalyst coated membranes (CCMs) are a major functional component of both fuel cells and electrolysers. Such CCMs generally comprise a conductive polymer membrane coated on either side by a catalyst containing layer. The CCMs are configured to drive oxidation and reduction reactions and support proton and electron transport, these processes been required for the fuel cell and electrolyser technologies to function.

While variations in CCM component materials and configurations exist according to functional performance requirements in end use applications, they generally contain several components of value including one or more platinum group metal (PGM) catalysts and one or more proton conducting polymers.

Typically, the membrane is formed of one or more ionomers such as perfluorosulfonic-acid (PFSA) ionomers. Ionomer may also be provided in one or both of the catalyst layers. The ionomer in the catalyst layers may be the same or different to the ionomer in the main membrane component and/or in the other catalyst layer(s).

A CCM may comprise two different catalysts, one for driving an oxidation reaction on one side of the CCM and one for driving a reduction reaction on the other side of the CCM. A CCM may also comprise a recombination catalyst which is provided to catalyse the recombination of hydrogen and oxygen to form water, reducing the quantity of hydrogen crossing the membrane and mixing with oxygen to form a potentially explosive mixture. A CCM may also include a metal oxide (e.g., CeO₂) as a peroxide scavenger to slow degradation of the CCM and increase the lifetime of the CCM.

CCM catalysts can be based on platinum group metals such as platinum, ruthenium, iridium, palladium, or mixtures thereof. The platinum group metals may be provided in elemental (metallic) form, in compound form (e.g., an oxide, such as an iridium oxide catalyst), or as a PGM-base metal alloy (e.g., PtCo). Furthermore, the PGM catalyst materials may be supported on a substrate material (e.g., carbon, such as a platinum-on-carbon catalyst comprising particles of carbon on which platinum is disposed or PtCo-on-carbon).

Catalyst coated membranes (CCMs) can also be provided in combination with additional functional layers to form multi-layer membrane electrode assemblies (MEAs). Such MEAs may have 3, 5, or 7 layers for example.

With the increase in CCM manufacture for fuel cells and electrolysers, there is an associated increase in CCM waste materials, including a significant volume of scrap material created during CCM manufacture (e.g., due to failure at quality control) and also an increase in end-of-life (EoL) CCMs. Since CCMs contain several components which are rare and/or valuable, including platinum group metals (notably Pt, Pd, Ir and Ru) and ionomer (both in the membrane and catalyst layers), there is a growing demand for methods of recycling such components from scrap/waste CCM materials.

One current method to recover PGMs from production scrap and end-of-life CCM material involves incineration. The incineration process yields a PGM rich (typically Pt and Ir) ash which is processed via conventional PGM refining routes. However, the incineration process releases harmful and toxic gases such as CO2 and HF from the polymers that are part of the membrane. Both these gases have negative impacts as they pollute the atmosphere, increase the greenhouse effect, and/or have harmful effects in the human body. As such, there is a need for a cleaner process which reduces or eliminates the emission of these gases.

In addition to the above, the incineration method destroys the ionomer component which also has significant value. As such, it would also be desirable to provide a process which is capable of recovering both PGM and ionomer components as well as providing a process which is cleaner, safer, and more environmentally friendly. Processes for recovering perfluorosulphonic acid ionomer are known. See, for example, WO2016/156815 and U.S. Pat. No. 7,255,798. Furthermore, processes for recovering individual PGM catalyst components are known. See, for example, U.S. Pat. No. 7,709,135. However, to enable fuel cells and electrolysers to become more sustainable technologies, there is a need for commercially viable and environmentally friendly routes to recover, separate, and recycle both the PGMs and the ionomer components from waste CCM materials including production scrap and end-of-life material. The present specification is concerned with a method for recycling ionomer materials (perfluorosulfonic acid (PFSA) polymers) from the ionomer membrane of a fuel cell or electrolyser.

WO2021250576 discloses a process for recycling ionomer materials from the ionomer membrane of a fuel cell or electrolyser. It is described that the solubility of fluorinated polymers used in such membranes decreases when the fluorinated polymers are heat-treated, as may be the case during the fabrication of a membrane comprising the fluorinated polymers. That is, while fluorinated polymers having a fluorinated backbone chain and a plurality of groups represented by formula —SO₃H or salts thereof dissolve easily in water and alcohol mixtures when they are newly prepared, after having been heated to temperatures of at least 100 °C, these polymers are typically insoluble in water and water/alcohol mixtures at standard conditions. WO2021250576 discloses that such heat-treated fluorinated polymers are soluble when heated in the presence of water and a base. As such, WO2021250576 discloses a method which involves dissolving a fluorinated polymer membrane in water and a base to form a fluorinated polymer salt solution and then converting the fluorinated polymer salt solution back to a fluorinated polymer solution by hydrogen cation exchange. It is indicated that the base is typically an alkali metal hydroxide (e.g., lithium hydroxide, sodium hydroxide, or potassium hydroxide) or an ammonium hydroxide. It is further indicated that the moles of base used may be equivalent to the moles of the fluorinated polymer, or an excess of base may be used (e.g., an excess of up to 100, 200, or 300 mole percent of base to fluorinated polymer).

It is an aim of the present specification to provide an improved process for recovery of ionomer.

### SUMMARY OF INVENTION

The present specification is concerned with recovering perfluorosulfonic acid (PFSA) polymers from scrap or used membranes such as those used in fuel cells or electrolysers. It has been recognized that the use of an equivalent or an excess of base, as described in WO2021250576, can be advantageous for ensuring that all, or substantially all, of the fluorinated polymer is converted to salt form. Salt formation protects the sulfonic acid groups during the recovery process and thus it is advantageous to ensure that all, or substantially all, of the sulfonic acid groups are converted to salt form during the process. However, it has also been recognized that the use of a base, such as a hydroxide as described in WO2021250576, can cause several problems in further processing of the ionomer material, particularly if the material being treated also includes one or more platinum group metal catalysts such as in a catalyst coated membrane.

Excess base can lead to etching/corrosive issues in equipment. Furthermore, excess base can cause issues in speciation and extraction of other components, such as platinum group metal catalysts which are present in a catalyst coated membrane of a fuel cell or electrolyser. Further still, any excess base needs to be recovered during the ion exchange process to convert the fluorinated polymer salt back to protonated acid form, which can adversely affect overall materials balance. For example, where a hydroxide is used as the base to convert the fluorinated polymer to salt form, excess hydroxide base is corrosive to metal and glass lined vessels which may be used in a subsequent dispersion process at elevated temperature and pressure. Furthermore, excess hydroxide base can cause issues in speciation and extraction of other components, such as platinum group metal catalysts which are present in a catalyst coated membrane of a fuel cell or electrolyser. Further still, any excess hydroxide base needs to be recovered during the ion exchange process to convert the fluorinated polymer salt back to protonated acid form, which can adversely affect overall materials balance.

As such, it has been recognized that if excess base is added to the fluorinated polymer to ensure substantially complete conversion of the fluorinated polymer to salt form, the excess base should be substantially removed during or immediately after conversion of the fluorinated polymer to salt form. Removal of excess base reduces etching/corrosive issues in equipment, reduces issues in speciation and extraction of other components such as platinum group metal components, and ensures that excess base does not need to be recovered during the subsequent ion exchange process to convert the fluorinated polymer salt back to acid form, hence improving overall materials balance. If the membrane is heated in a basic solution to form a dispersion of fluorinated polymer salt in the basic solution as described in WO2021250576, it is difficult to separate the fluorinated polymer salt from excess base. However, it has been found that membrane material can be treated with a basic solution to form a salt without heating the membrane to temperatures at which it disperses in the basic solution. This allows the membrane to be retained in solid salt form which is readily separated from the basic solution prior to further processing.

In addition to the above, while WO2021250576 proposes the use of a base in the form of an alkali metal hydroxide (e.g., lithium hydroxide, sodium hydroxide, or potassium hydroxide) or an ammonium hydroxide, it has been found that other reagents can be used to convert the fluorinated polymer to salt form. For example, it has been found that a carbonate salt can be used, thus reducing or avoiding the aforementioned problems associated with the use of a hydroxide base. As such, in addition to removing excess salt forming reagent when converting the fluorinated polymer to salt form, it can also be advantageous to use a carbonate salt as the salt forming reagent where the carbon dioxide decomposition product produced on formation of the sulfonic acid salt can be removed as a gaseous product therefore avoiding generation of a highly corrosive alkaline solution and avoiding the requirement for significant washing steps.

It has also been found that as a further alternative to the use of hydroxides and carbonates as salt forming reagents for converting the fluorinated polymer to salt, other reagents can be used as the source of cations to generate the polymer salt. Such reagents include inorganic salts such as halide salts (e.g., chlorides, for example metal chlorides such as sodium chloride or lithium chloride). Alternatively, organic salts can be used as the source of cations to generate the polymer salt (e.g., formates (for example lithium formate), acetates, oxalates, citrates, or gluconates). Further still, the cations may be inorganic cations (i.e., metal cations) or organic cations such as NH₄⁺. Other options for the reagent include hydrogen carbonates, carbamates, nitrates, phosphates, and sulfates which may, for example, be in metal or ammonium salt form.

According to the present specification, such a reagent is added to the fluorinated polymer to convert the fluorinated polymer to salt form without heating to sufficient temperatures to disperse the membrane such that the membrane remains in solid, undispersed form. Excess, unreacted reagent is then removed from the solid polymer salt prior to dispersion of the solid polymer salt in a solvent. Removal of excess, unreacted reagent reduces etching/corrosive issues in equipment, reduces issues in speciation and extraction of other components such as platinum group metal components, and ensures that excess reagent does not need to be recovered during the subsequent ion exchange process to convert the fluorinated polymer salt back to acid form, hence improving overall materials balance.

The present specification thus provides a method of recycling a fluorinated polymer from a membrane comprising the fluorinated polymer, the fluorinated polymer comprising a fluorinated polymer backbone chain and a plurality of groups represented by formula —SO₃Z, wherein Z is hydrogen, the method comprising:
contacting the membrane with a reagent providing a source of cations to form a fluorinated polymer salt in which Z is a cation, wherein the reagent is maintained at a temperature sufficiently low that the membrane remains in a solid, undispersed form;
removing excess, unreacted reagent from the solid fluorinated polymer salt; and
after removing the excess reagent, dispersing the solid fluorinated polymer salt in a solvent.

For example, where the reagent is a base, the method comprises:
contacting the membrane with an aqueous basic solution comprising water and a base to form a fluorinated polymer salt in which Z is a cation, wherein optionally a molar excess of base over —SO₃Z groups is provided, and wherein the aqueous basic solution is maintained at a temperature sufficiently low that the membrane remains in a solid, undispersed form;
removing the excess/unreacted base by separating the solid fluorinated polymer salt from the aqueous basic solution (e.g., by a solid-liquid separation technique); and
after removing the excess base, dispersing the solid fluorinated polymer salt in a solvent.

In another example, the reagent is a carbonate and the method comprises:
contacting the membrane with an aqueous carbonate solution comprising water and a carbonate to form a fluorinated polymer salt wherein Z is a cation, wherein optionally a molar excess of carbonate over —SO₃Z groups is provided to form the fluorinated polymer salt, and wherein the aqueous carbonate solution is maintained at a temperature sufficiently low that the membrane remains in a solid, undispersed form;
removing the excess/unreacted carbonate from the solid fluorinated polymer salt; and
dispersing the fluorinated polymer salt in a solvent after removing the excess carbonate.

Optionally, after dispersing the solid fluorinated polymer salt in the solvent, the fluorinated polymer salt is converted back to a fluorinated polymer wherein Z is hydrogen by cation exchange. This can be done immediately following the dispersal step. Alternatively, the dispersed polymer salt can be dried and stored, and then re-dispersed and converted to protonated form later when required for use.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a flow diagram of the method steps for recycling fluorinated polymer membrane material;

FIG. 2 shows FTIR data for fluorinated polymer membrane material, fluorinated polymer salt material formed after treatment in water and base, and fluorinated polymer salt material formed after treatment in water and base followed by a water wash;

FIG. 3 shows an example of process steps (pre-autoclave) including refluxing fluorinated polymer membrane in a basic LiOH solution to form a fluorinated polymer salt without dispersing the membrane followed by washing with water;

FIG. 4 is a photograph showing the membrane before (left hand side) and after (right hand side) the process steps of refluxing the membrane in a basic LiOH solution and washing with water;

FIG. 5 shows a further step of autoclaving the membrane following the treatment process as shown in FIG. 3 to disperse the membrane in water;

FIG. 6 shows a further step (post-autoclave) of ion exchange to convert the dispersed polymer salt back to protonated acid form;

FIG. 7 shows a flow diagram of the method steps for recycling fluorinated polymer membrane material according to another example using a carbonate reagent rather than a hydroxide reagent;

FIG. 8 shows an example of process steps (prior to dispersal of membrane) including refluxing fluorinated polymer membrane in a Li₂CO₃ solution to form a fluorinated polymer salt without dispersing the membrane, followed by washing with water; and

FIG. 9 shows FTIR ATR spectra of PFSA ionomer membrane subject to 1 and 2 molar equivalents Na as Na₂CO₃ relative to SO₃ in membrane.

### DETAILED DESCRIPTION

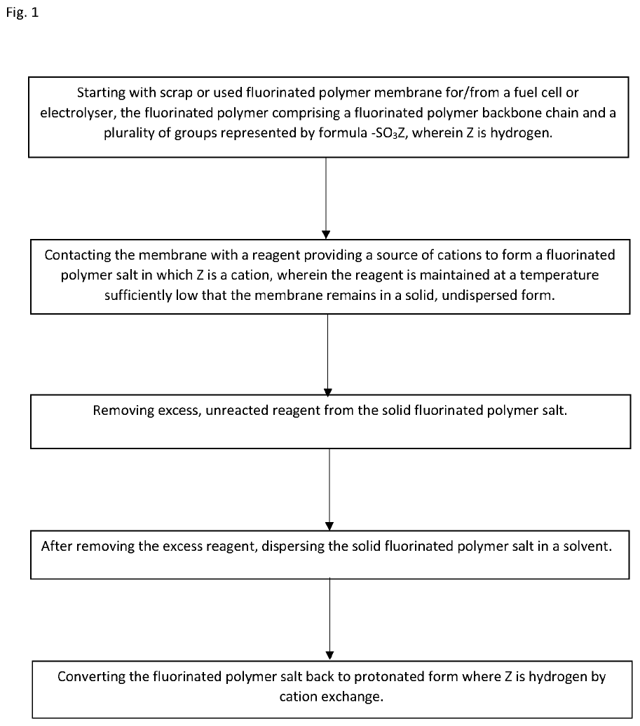

As illustrated in FIG. 1, the present specification provides a method of recycling a fluorinated polymer from a membrane comprising the fluorinated polymer. The fluorinated polymer comprises a fluorinated polymer backbone chain and a plurality of groups represented by formula —SO₃Z. Z can be hydrogen or a cation such as a metal cation, an alkali-metal cation, or a quaternary ammonium cation (ammonium or alkylammonium cation). In accordance with examples of the present method, Z is hydrogen in at least some of the —SO₃Z groups.

The method comprises:
contacting the membrane with a reagent providing a source of cations to form a fluorinated polymer salt in which Z is a cation, wherein the reagent is maintained at a temperature sufficiently low (e.g., below 150 °C, 100 °C, 80 °C, 60 °C, or 40 °C, optionally greater than 5 °C, 10 °C or 15 °C) that the membrane remains in a solid, undispersed form;
removing excess, unreacted reagent from the solid fluorinated polymer salt (e.g., using a solid-liquid separation technique, optionally decanting and filtering); and
after removing the excess reagent, dispersing the solid fluorinated polymer salt in a solvent (e.g., water). The ionomer can then be dried and stored as a salt which can later be redispersed for use. Alternatively, after dispersing the solid fluorinated polymer salt in the solvent, the fluorinated polymer salt can be converted back to a fluorinated polymer wherein Z is hydrogen by cation exchange.

Optionally, the reagent is provided in equivalent or excess quantities such that the reagent provides a molar equivalent or a molar excess of the cations over the —SO₃Z groups. The solid fluorinated polymer salt can be washed in a solvent, optionally water, after separating the solid fluorinated polymer salt from the reagent and prior to dispersing the solid fluorinated polymer salt in the solvent. This ensures that all, or substantially all, of the excess, unreacted reagent is removed from the membrane prior to dispersal in the solvent. The solid fluorinated polymer salt can then be dispersed in the solvent by heating the solid fluorinated polymer salt in the solvent to a temperature of at least 180°C, 200 °C, 220 °C, 240 °C, or 250 °C (optionally no more than 500 °C, 400 °C, or 300 °C), e.g., using an autoclave.

The reagent providing the source of cations to form the fluorinated polymer salt can be selected from one or more of: a base; a hydroxide; a metal hydroxide; an ammonium hydroxide; a carbonate; a metal carbonate; an alkali metal carbonate; an alkaline earth metal carbonate; an ammonium carbonate; a halide; a metal halide; an organic salt; a formate; an acetate; an oxalate; a citrate; a gluconate; a source of inorganic cations; a source of metal cations; a source of organic cations; a source of NH₄⁺; a hydrogen carbonate; a carbamate; a nitrate; a phosphate; and a sulfate.

### Examples Where the Reagent is a Base (e.g., a Hydroxide)

According to certain examples, the reagent is a base, and the method comprises contacting the membrane with an aqueous basic solution comprising water and a base (e.g., a hydroxide such as an alkali metal hydroxide or an ammonium hydroxide) to form a fluorinated polymer salt. The solid fluorinated polymer salt can then be dispersed in a solvent and optionally the fluorinated polymer salt can be converted back to a fluorinated polymer wherein Z is hydrogen by cation exchange. A molar excess of base over —SO₃Z groups can be provided in the step of contacting the membrane with the aqueous basic solution to form the fluorinated polymer salt, and the excess base is removed prior to dispersing the membrane and optionally converting the fluorinated polymer salt to the fluorinated polymer by cation exchange. As described in the summary section, according to the present specification excess base is added to the fluorinated polymer to ensure substantially complete conversion of the fluorinated polymer to salt form, but the excess base is substantially removed during or immediately after conversion of the fluorinated polymer to salt form. Removal of excess/unreacted base reduces etching/corrosive issues in equipment, reduces issues in speciation and extraction of other components such as platinum group metal components, and ensures that excess base does not need to be recovered during the subsequent ion exchange process to convert the fluorinated polymer salt back to acid form, hence improving overall materials balance.

The aqueous basic solution is maintained at a temperature sufficiently low that the membrane remains in a solid, undispersed form during the step of contacting the membrane with the aqueous basic solution to form the fluorinated polymer salt in a solid, undispersed form. This contrasts with prior art methods in which the membrane is heated in an aqueous basic solution to disperse the membrane. It has been found that the fluorinated polymer membrane can be converted to salt form without dispersing the membrane. This is advantageous because the excess base is then easily removed by separating the solid fluorinated polymer salt from the aqueous basic solution, for example by a solid-liquid separation technique, optionally decanting or filtering. The solid fluorinated polymer salt can then be dispersed in a (non-basic) solvent, optionally water, prior to converting the fluorinated polymer salt to the fluorinated polymer by cation exchange. As previously indicated, removal of excess base in this manner reduces etching/corrosive issues in equipment, reduces issues in speciation and extraction of other components such as platinum group metal components, and ensures that excess base does not need to be recovered during the subsequent ion exchange process to convert the fluorinated polymer salt back to acid form, hence improving overall materials balance.

During the step of contacting the membrane with the aqueous basic solution to form the fluorinated polymer salt, the aqueous basic solution can be maintained at a temperature below 150 °C, 100 °C, 80 °C, 60 °C, or 40 °C, optionally greater than 5 °C, 10 °C or 15 °C, optionally within a range defined by any of the preceding upper and lower values (e.g., room temperature). The temperature can be sufficiently low such that the conversion of the fluorinated polymer to salt form is achieved without dispersing the fluorinated polymer membrane which remains in solid, undispersed form.

After separating the solid fluorinated polymer salt from the aqueous basic solution and prior to dispersing the solid fluorinated polymer salt in the solvent, the solid fluorinated polymer salt can be washed in a solvent, optionally water.

After forming the fluorinated polymer salt, and optionally washing, the solid fluorinated polymer salt can be dispersed in a solvent (e.g., water) by heating the solid fluorinated polymer salt in the solvent to a temperature of at least 180 °C, 200 °C, 220 °C, 240 °C, or 250 °C (optionally no more than 500 °C, 400 °C, or 300 °C) prior to converting the fluorinated polymer salt to the fluorinated polymer by cation exchange.

In the above-described process, the fluorinated polymer membrane is converted to salt form without dispersing the membrane. Dispersal is then achieved in a further process step without the use of a base.

The base used to form the fluorinated polymer salt can be a hydroxide. Optionally the base is a metal hydroxide, optionally an alkali metal hydroxide (e.g., LiOH or NaOH) or an ammonium hydroxide. The solid salt can be stored as an intermediate product until it is needed for use in producing new fluorinated polymer or converted immediately into fluorinated polymer. In this regard, the fluorinated polymer salt can then be dispersed (e.g., by autoclaving in water) prior to the step of converting the fluorinated polymer salt to the fluorinated polymer by cation exchange. After converting the fluorinated polymer salt to the fluorinated polymer by cation exchange, the fluorinated polymer can be re-used to manufacture a new membrane.

The membrane can be a catalyst coated membrane for a fuel cell or electrolyser. In this case, it is desirable to recycle the catalyst components and the polymer material of the membrane. As such, at least one catalyst material can be separated from the membrane prior to heating the membrane in the presence of water and base to form a fluorinated polymer salt and/or at least one catalyst material can be separated from the fluorinated polymer or fluorinated polymer salt after heating the membrane in the presence of water and base to form the fluorinated polymer salt.

### Experimental

Perfluorosulfonic-acid ionomer membrane pieces were cut into sufficiently small pieces to fit in a vessel. 6.0 g of anhydrous LiOH and 250 g of water were weighed and the LiOH dissolved in the water. The membrane pieces were submerged in the LiOH solution and heated to reflux for 1 hour. The resultant mixture was washed out with 4×100 mL of water. The remaining water was decanted to leave (wet) membrane pieces. 250 g of water was weighed, added to the (wet) membrane pieces, and heated to reflux for 1 hour. The water was then decanted off and the solid product dried under vacuum.

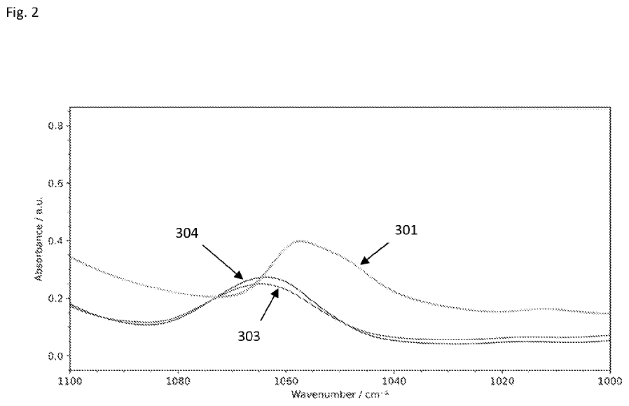

FIG. 2 shows FTIR data showing salt formation. FTIR data was collected for untreated fluorinated polymer membrane material 301, fluorinated polymer salt material formed after treatment in the aqueous solution of LiOH 303, and fluorinated polymer salt material formed after treatment in the aqueous solution of LiOH followed by the water wash 304.

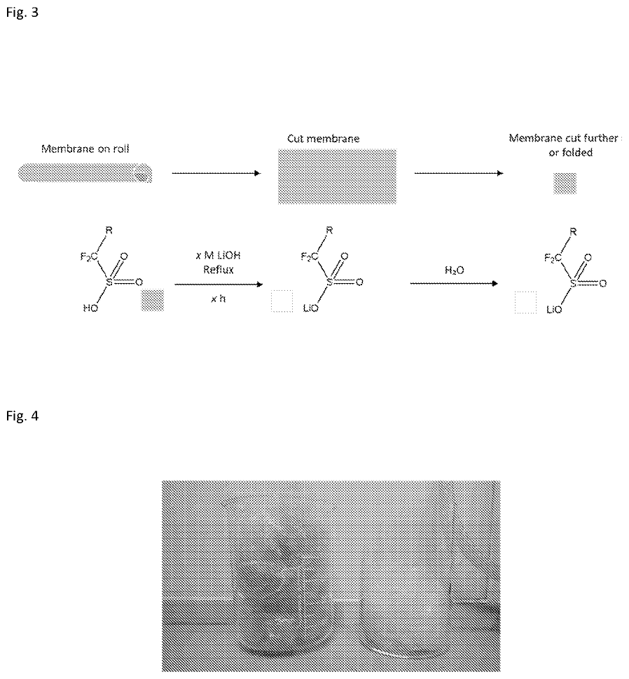

FIG. 3 shows an example of process steps (pre-autoclave). Membrane on a roll was cut and then further cut or folded to size. The membrane was brown in colouration as indicated in the figure. The membrane was then refluxed in a solution of lithium hydroxide wherein the membrane turned colourless and converted to salt form as confirmed by spectroscopic analysis. The conversion was achieved without dispersing the membrane which remained in solid, undispersed form.

It may be noted that the colour change of the membrane is not necessarily indicative of the chemical change and membranes can have different colours. However, in the illustrative examples the chemical change of the polymer from protonated to salt form was accompanied by an associated colour change as shown in the figures.

In the final step of the pre-autoclave process shown in FIG. 3, the solid polymer salt membrane material was washed in water to remove any residual LiOH solution. FIG. 4 is a photograph showing the membrane before (left hand side) and after (right hand side) the process steps of refluxing the membrane in a basic LiOH solution and washing with water indicating the colour change of the membrane from brown to colourless and the fact that the membrane remained in solid, undispersed form. Spectroscopic analysis confirmed that the colourless membrane was in salt form.

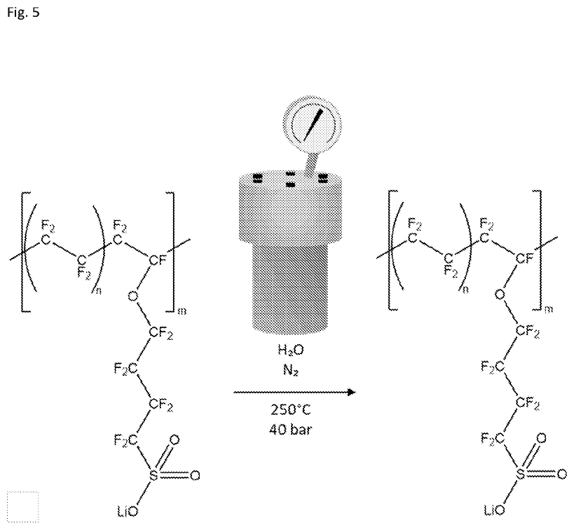

FIG. 5 shows a further step of autoclaving the membrane following the treatment process as shown in FIG. 3 to disperse the membrane in water. The colourless, solid, undispersed, polymer salt membrane was autoclaved in water under nitrogen at 250 °C and 40 bar (4000 kPa) pressure. This resulted in a (non-basic) aqueous dispersion of the polymer salt.

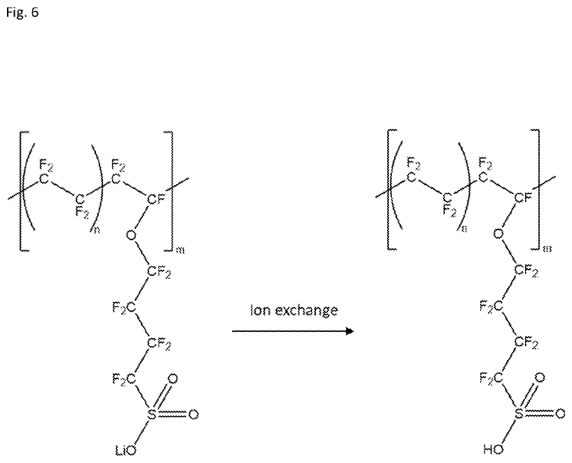

FIG. 6 shows a further step (post-autoclave) of ion exchange to convert the dispersed polymer salt back to protonated acid form. An ion exchange column containing Amberlyst™ 15 (H) resin was utilized for this process step. The dispersion of (protonated) fluorinated polymer may be re-used to manufacture new membranes or dried and stored for future use.

### Examples Where the Reagent Is a Carbonate

As an alternative to using a base such as a hydroxide as described above, according to other examples of the present methodology a carbonate is used as the reagent for converting the fluorinated polymer membrane to salt form prior to dispersion of the membrane.

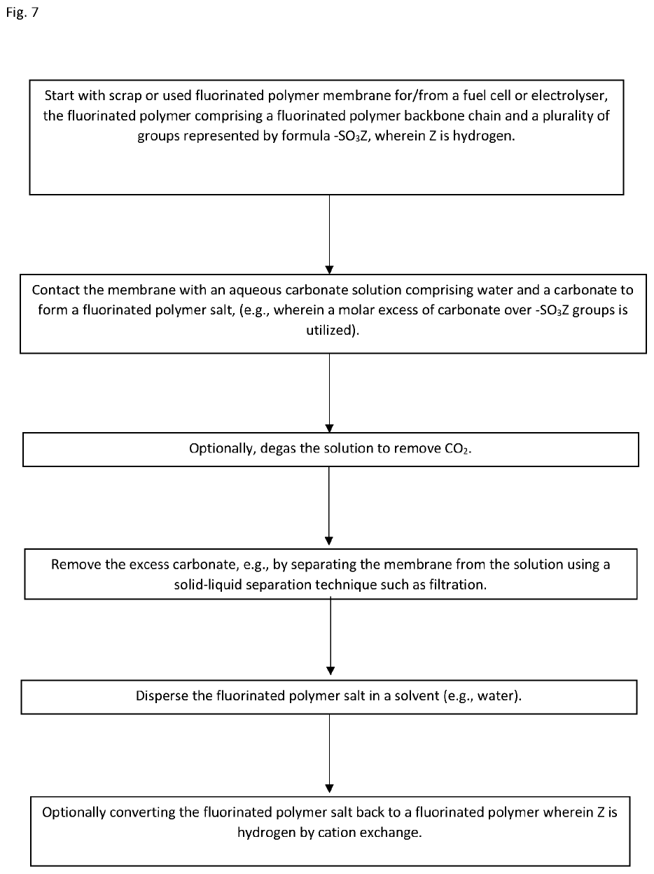

As illustrated in FIG. 7, this method also provides a method of recycling a fluorinated polymer from a membrane comprising the fluorinated polymer. The fluorinated polymer again comprises a fluorinated polymer backbone chain and a plurality of groups represented by formula —SO₃Z, wherein Zis hydrogen. The method comprises: contacting the membrane with an aqueous solution comprising water and a carbonate (e.g., a metal carbonate, an alkali metal carbonate, an alkaline earth metal carbonate, or an ammonium carbonate) to form a fluorinated polymer salt. The fluorinated polymer salt can then be dispersed in a solvent and optionally converted back to a fluorinated polymer wherein Z is hydrogen by cation exchange.

As described in the summary section, use of a carbonate salt (rather than a hydroxide) where the carbon dioxide decomposition product produced on formation of the sulfonic acid salt can be removed as a gaseous product avoids generation of a highly corrosive alkaline solution and avoids the requirement for significant washing steps.

The aqueous carbonate solution can be degassed to remove carbon dioxide from the aqueous carbonate solution which is formed during reaction of the carbonate with the —SO₃Z groups. Degassing can be achieved by heating the aqueous carbonate solution and/or reducing the pressure above the aqueous carbonate solution. Furthermore, the step of contacting the membrane with carbonate solution to form the fluorinated polymer salt can be performed in a vessel which has atmosphere control including a pressure relief regulator to ensure released carbon dioxide does not over-pressurise the vessel. Further still, after the step of contacting the membrane with carbonate solution to form the fluorinated polymer salt, the atmosphere in the vessel can be replaced with an inert gas, optionally nitrogen. As an alternative to using a sealed vessel, the membrane can be contacted with the carbonate in an open vessel.

Thus, according to an example of the present specification, a PFSA membrane (e.g., scrap membrane material generated during manufacture of membranes for fuel cells or electrolysers or used/waste membrane from such devices) is treated with a solution of a carbonate salt of sufficient concentration and volume to fully convert the sulfonic acid to the corresponding salt. The materials are thoroughly mixed for sufficient time (optionally with heating) for the ion exchange conversion of the sulfonic acid to salt. The mixture can then be heated to displace the carbon dioxide from the solution, optionally reducing the pressure to facilitate degassing of the solution. The carbonate salt and ionomer can be added directly to an autoclave or pressure reactor fitted with atmosphere control and pressure relief regulation to ensure the carbon dioxide released does not over-pressurise the vessel during the formation of the sulfonic acid salt and enable a change of atmosphere from carbon dioxide to nitrogen after completion of the sulfonic acid salt formation.

A molar excess of carbonate over —SO₃Z groups can be provided in the step of contacting the membrane with carbonate solution to form the fluorinated polymer salt, and the excess carbonate salt can be removed prior to dispersing the membrane and converting the fluorinated polymer salt back to the protonated fluorinated polymer by cation exchange. Excess carbonate is added to the fluorinated polymer to ensure substantially complete conversion of the fluorinated polymer to salt form, and the excess carbonate can be substantially removed during or immediately after conversion of the fluorinated polymer to salt form. Removal of excess carbonate reduces issues in speciation and extraction of other components such as platinum group metal components, and ensures that excess carbonate does not need to be recovered during the subsequent ion exchange process to convert the fluorinated polymer salt back to acid form, hence improving overall materials balance.

Advantageously, the aqueous carbonate solution is maintained at a temperature sufficiently low that the membrane remains in a solid, undispersed form during the step of contacting the membrane with the aqueous carbonate solution to form the fluorinated polymer salt in a solid, undispersed form. This contrasts with prior art methods in which the membrane is heated in an aqueous basic solution to disperse the membrane. It has been found that the fluorinated polymer membrane can be converted to salt form using a carbonate reagent without dispersing the membrane. This is advantageous because the excess carbonate is then easily removed by separating the solid fluorinated polymer salt from the aqueous carbonate solution by a solid-liquid separation technique, optionally decanting or filtering. Alternatively, excess carbonate (e.g., ammonium carbonate) can be removed using a thermal treatment (noting that ammonium carbonate, other organic carbonates, and/or other ammonium salts can be removed using a thermal treatment as an alternative to a solid-liquid separation technique such as filtration). The solid fluorinated polymer salt can then be dispersed in a (non-basic) solvent, optionally water, prior to converting the fluorinated polymer salt to the fluorinated polymer by cation exchange. As previously indicated, removal of excess carbonate reduces issues in speciation and extraction of other components such as platinum group metal components, and ensures that excess carbonate does not need to be recovered during the subsequent ion exchange process to convert the fluorinated polymer salt back to acid form, hence improving overall materials balance.

During the step of contacting the membrane with the aqueous carbonate solution to form the fluorinated polymer salt, the aqueous carbonate solution can be maintained at a temperature below 150 °C, 100 °C, 80 °C, 60 °C, or 40 °C, optionally greater than 5 °C, 10 °C or 15 °C, optionally within a range defined by any of the preceding upper and lower values (e.g., room temperature). The temperature can be sufficiently low such that the conversion of the fluorinated polymer to salt form is achieved without dispersing the fluorinated polymer membrane which remains in solid, undispersed form.

After separating the solid fluorinated polymer salt from the aqueous carbonate solution and prior to dispersing the solid fluorinated polymer salt in a dispersion solvent, the solid fluorinated polymer salt can be washed in a washing solvent, optionally water.

After forming the fluorinated polymer salt, and optionally washing, the solid fluorinated polymer salt can be dispersed in a solvent (e.g., water) by heating the solid fluorinated polymer salt in the solvent to a temperature of at least 180 °C, 200 °C, 220 °C, 240 °C, or 250 °C prior to converting the fluorinated polymer salt to the fluorinated polymer by cation exchange.

In the above-described preferred process, the fluorinated polymer membrane is converted to salt form without dispersing the membrane. Dispersal is then achieved in a further process step without the use of a base/carbonate.

The solid salt can be stored as an intermediate product until it is needed for use in producing new fluorinated polymer or converted immediately into protonated fluorinated polymer. In this regard, the fluorinated polymer salt can then be dispersed (e.g., by autoclaving in water) prior to the step of converting the fluorinated polymer salt to the fluorinated polymer by cation exchange. After converting the fluorinated polymer salt to the fluorinated polymer by cation exchange, the fluorinated polymer can be re-used to manufacture a new membrane.

The membrane can be a catalyst coated membrane for a fuel cell or electrolyser. In this case, it is desirable to recycle the catalyst components and the polymer material of the membrane. As such, at least one catalyst material can be separated from the membrane prior to contacting the membrane with carbonate solution to form a fluorinated polymer salt and/or at least one catalyst material can be separated from the fluorinated polymer or fluorinated polymer salt after contacting the membrane with carbonate solution to form the fluorinated polymer salt.

### Experimental

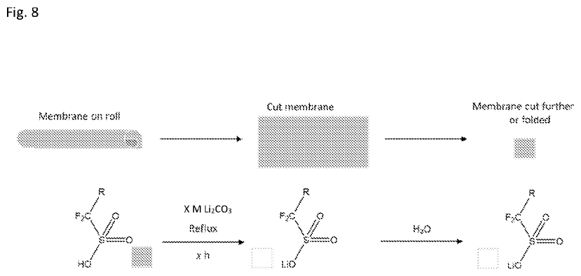

FIG. 8 shows an example of process steps (pre-autoclave). Membrane on a roll was cut and then further cut or folded to size. The membrane was brown in colouration as indicated in the figure. The membrane was then refluxed in a solution of lithium carbonate wherein the membrane turned colourless and converted to salt form as confirmed by spectroscopic analysis. The conversion was achieved without dispersing the membrane which remained in solid, undispersed form.

It may be noted that the colour change of the membrane is not necessarily indicative of the chemical change and membranes can have different colours. However, in the illustrative examples the chemical change of the polymer from protonated to salt form was accompanied by an associated colour change as shown in the figures.

In the final step of the pre-autoclave process shown in FIG. 8, the solid polymer salt membrane material was washed in water to remove any residual lithium carbonate solution. Spectroscopic analysis confirmed that the colourless membrane was in salt form.

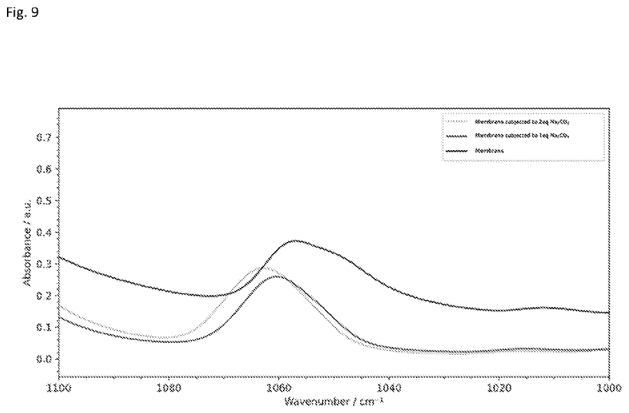

According to one example, sodium carbonate (0.73 g, 6.88 mmol) was dissolved in deionised water (200 mL). A portion of perfluorosulfonic-acid ionomer membrane (6.25 mmol SO₃⁻) was immersed in a portion of the sodium carbonate solution (100 mL) for 1 hour and boiled for a further hour. The resulting membrane was washed with deionised water and dried under vacuum. FTIR of the membrane before and after ion-exchange (membrane subject to 1 equivalent Na as Na₂CO₃, see FIG. 9) shows a shift in the symmetric stretch of the sulfinate group (SO₃⁻) at ca. 1050-1060 cm⁻¹ indicating a change in environment, interpreted as successful ion-exchange. The basicity of the solution after ion exchange and boiling decreased from 0.04 M [OH⁻] to 0.00 M [OH⁻] by titration with HCl.

A second example followed the same methodology but used twice the amount of sodium carbonate (1.46 g, 13.75 mmol). FTIR of the membrane before and after ion-exchange (membrane subject to 2 equivalents Na as Na₂CO₃, see FIG. 9) shows a similar shift in the symmetric stretch of the sulfinate group (SO₃⁻) . The basicity of the solution after ion exchange and boiling decreased from 0.06 M [OH⁻] to 0.02 M [OH⁻] by titration with HCl and pH reduced from 11.1 to 8.4.

As previously described in the hydroxide reagent example with reference to FIG. 5, a further step of autoclaving the membrane following the treatment process of FIG. 8 can be used to disperse the membrane in water. The colourless, solid, undispersed, polymer salt membrane can be autoclaved in water under nitrogen at 250 °C and 40 bar (4000 kPa) pressure. This results in a (non-basic) aqueous dispersion of the polymer salt.

Furthermore, as previously described in the hydroxide reagent example with reference to FIG. 6, a further step (post-autoclave) of ion exchange can be used to convert the dispersed polymer salt back to protonated acid form. An ion exchange column containing Amberlyst™ 15 (H) resin can be utilized for this process step. The dispersion of (protonated) fluorinated polymer may then be re-used to manufacture new membranes or dried and stored for future use.

### Alternative Salt Forming Reagents

It has also been confirmed that other reagents can be used to provide the source of cations required to form a fluorinated polymer salt in which Z is a cation while the membrane remains in a solid, undispersed form. For example, metal chloride solutions have been used for this purpose.

While this invention has been particularly shown and described with reference to certain examples, it will be understood to those skilled in the art that various changes in form and detail may be made without departing from the scope of the invention as defined by the appended claims.

1. A method of recycling a fluorinated polymer from a membrane comprising the fluorinated polymer, the fluorinated polymer comprising a fluorinated polymer backbone chain and a plurality of groups represented by formula —SO₃Z, wherein Z is hydrogen, the method comprising:
contacting the membrane with a reagent providing a source of cations to form a fluorinated polymer salt in which Z is a cation, wherein the reagent is maintained at a temperature sufficiently low that the membrane remains in a solid, undispersed form;
removing excess, unreacted reagent from the solid fluorinated polymer salt
after removing the excess reagent, dispersing the solid fluorinated polymer salt in a solvent; and
after dispersing the solid fluorinated polymer salt in the solvent, converting the fluorinated polymer salt back to a fluorinated polymer wherein Z is hydrogen by cation exchange.

2. (canceled)

3. A method according to claim 1,
wherein the excess, unreacted reagent is removed from the solid fluorinated polymer salt using a solid-liquid separation technique, optionally decanting and filtering.

4. A method according to claim 1,
wherein the solvent used to disperse the solid fluorinated polymer salt after removing the excess base is water.

5. A method according to claim 1,
wherein the reagent is maintained at a temperature below 150 C, 100 C, 80 C, 60 C, or 40 during the step of contacting the membrane with the reagent to form the fluorinated polymer salt.

6. A method according to claim 1,
wherein the solid fluorinated polymer salt is washed in a solvent, optionally water, after separating the solid fluorinated polymer salt from the reagent and prior to dispersing the solid fluorinated polymer salt in the solvent.

7. A method according to claim 1,
wherein the solid fluorinated polymer salt is dispersed in the solvent by heating the solid fluorinated polymer salt in the solvent to a temperature of at least 180 C, 200 °C, 220 C, 240 C, or 250 C.

8. A method according to claim 1,
wherein the reagent providing the source of cations to form the fluorinated polymer salt is selected from one or more of: a base; a hydroxide; a metal hydroxide; an ammonium hydroxide; a carbonate; a metal carbonate; an alkali metal carbonate; an alkaline earth metal carbonate; an ammonium carbonate; a halide; a metal halide; an organic salt; a formate; an acetate; an oxalate; a citrate; a gluconate; a source of inorganic cations; a source of metal cations; a source of organic cations; a source of NH₄⁺; a hydrogen carbonate; a carbamate; a nitrate; a phosphate; and a sulfate.

9. A method according to claim 1, wherein the reagent provides a molar equivalent or a molar excess of the cations over the —SO₃Z groups.

10. A method according to claim 1,
wherein the reagent is in aqueous solution.

11. A method according to claim 1,
wherein the reagent is a base, optionally a hydroxide.

12. A method according to claim 1,
wherein the reagent is an aqueous carbonate solution, optionally a metal carbonate, an alkali metal carbonate, an alkaline earth metal carbonate, or an ammonium carbonate.

13. A method according to claim 12,
wherein the aqueous carbonate solution is degassed to remove carbon dioxide formed during reaction of the carbonate with the —SO₃Z groups, degassing being achieved by heating the aqueous carbonate solution and/or reducing pressure above the aqueous carbonate solution.

14. A method according to claim 12,
wherein the step of contacting the membrane with the aqueous carbonate solution to form the fluorinated polymer salt is performed in a vessel which has atmosphere control including a pressure relief regulator to ensure released carbon dioxide does not over-pressurise the vessel.

15. A method according to claim 12,
wherein after the step of contacting the membrane with the aqueous carbonate solution to form the fluorinated polymer salt, the atmosphere in the vessel is replaced with an inert gas, optionally nitrogen.

16. A method according to claim 1,
wherein after converting the fluorinated polymer salt to the fluorinated polymer by cation exchange, the fluorinated polymer is re-used to manufacture a new membrane.

17. A method according to claim 1,
wherein the membrane is a catalyst coated membrane for a fuel cell or electrolyser.

18. A method according to claim 17,
wherein at least one catalyst material is separated from the membrane prior to contacting the membrane with the reagent.

19. A method according to claim 17,
wherein at least one catalyst material is separated from the fluorinated polymer or fluorinated polymer salt after contacting the membrane with the reagent.
